(19) United States
(12) Patent Application Publication
(10) Pub. No.: US 2007/0143573 A1
(43) Pub. Date: Jun. 21, 2007

(54) Data processing apparatus and method using translation table emulation

(75) Inventor: Jin-Kwon Park, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/483,450

(22) Filed: Jul. 10, 2006

(30) Foreign Application Priority Data
Dec. 20, 2005 (KR) 10-2005-0126077

(51) Int. Cl. G06F 12/00

(52) U.S. Cl. 711/207

(57) ABSTRACT

A data processing system comprising a central processing unit (CPU), a memory management unit (MMU), and a translation table emulation module (TTE). The CPU outputs a virtual address. The MMU generates a translation table address corresponding to the virtual address and transforms the virtual address into a physical address from a descriptor. The TTE receives the translation table address and generates the descriptor needed to map the virtual address to the physical address.

### CROSS-REFERENCE TO RELATED PATENT APPLICATIONS

This application claims priority to Korean Patent Application No. 2005-0126077, filed on Dec. 20, 2006, in the Korean Intellectual Property Office, the disclosure of which is incorporated by reference herein.

### BACKGROUND OF THE INVENTION

1. Technical Field

The present disclosure relates to a data processing system, and more particularly, to an improved data processing system and method for efficiently processing data by using translation table emulation.

2. Discussion of the Related Art

The capacity of a basic memory in a personal computer system has been greatly increased to handle the storage of multimedia data. However, in order to maximize performance due to the increased capacity, it is necessary to efficiently manage the basic memory. Conventional general processors have been designed to include a function for efficiently managing a large capacity of memory. This function is known in the art as a memory management unit (MMU) and is commonly implemented as a separate functional block.

The MMU is generally a hardware device that manages a virtual memory system. Although normally constructed as part of the central processing unit (CPU), the MMU may be designed as a separate chip. Commands that instruct data to be read are first transmitted to the MMU to determine whether the data can be read directly from a random access memory (RAM) or must be fetched from a hard disk. If the data is not stored in the RAM, the MMU generates an interrupt indicating that a page fault has occurred.

A conventional processor that utilizes the MMU to access virtual addresses executes a program to perform an initialization process to match all virtual addresses with corresponding physical addresses, creating a translation table. Even if the program adopts the simplest mapping method, all addresses must be individually initialized. A large amount of program resources are needed to initialize all the addresses, and depending upon the program used, may require as much as 300 ms to complete. The translation table is generally loaded into an external memory. However, a part of the translation table may be loaded into an internal memory in the form of a cache. The translation table has a data list needed to map virtual addresses to corresponding physical addresses. Directly accessing a translation table loaded into an external memory requires additional access time and a large amount of code to drive the translation table. Since the translation table has a large size, less memory is available to the system. Therefore a need exists for generating translation table data and physical addresses without accessing a translation table loaded into an external memory.

### SUMMARY OF THE INVENTION

According to an exemplary embodiment of the present invention, there is provided a data processing system that includes a central processing unit (CPU), a memory management unit (MMU), and a translation table emulation (TTE) module. The CPU outputs a virtual address. The MMU generates a translation table address corresponding to the virtual address, and transforms the virtual address to a physical address by using a descriptor. The translation table emulation module receives the translation table address, and generates the descriptor needed to map the virtual address to the physical address.

According to an exemplary embodiment of the present invention, there is provided a data processing system that includes a memory management unit (MMU) and a translation table emulation module. The MMU transforms a virtual address into a physical address by using a descriptor having a plurality of attribute values. The translation table emulation module receives a translation table address that is based on the virtual address, and generates the descriptor by setting the attribute values based on the translation table address.

The translation table emulation module may include a start address register outputting a predetermined start address, an operation unit, a decoder, and a field generator. The operation unit computes a section base address from the start address and a lower address of the translation table address. The decoder outputs a cache value and a buffer value corresponding to an upper address of the translation table address. The field generator generates the descriptor based on the cache value, the buffer value, and the section base address.

According to an exemplary embodiment of the present invention, there is provided a method of processing data, the method including generating a translation table address corresponding to a virtual address, generating a descriptor by setting a plurality of attribute values based on the translation table address and generating the descriptor to include the attribute values, transforming the virtual address into a physical address by using the descriptor, and accessing the data by using the physical address.

### BRIEF DESCRIPTION OF THE DRAWINGS

The above and other aspects of the present invention will become more apparent by describing in detail exemplary embodiments thereof with reference to the attached drawings in which:

FIG. 1 is a schematic block diagram of a data processing system according to an exemplary embodiment of the present invention;

FIG. 2 is a block diagram illustrating the operation of the data processing system of FIG. 1;

FIG. 3 is a block diagram of a translation table emulation unit according to an exemplary embodiment of the present invention;

FIG. 4 is a detailed diagram illustrating the structure of a descriptor according to an exemplary embodiment of the present invention;

FIG. 5 is a detailed diagram illustrating the structure of a translation table according to an exemplary embodiment of the present invention; and

FIG. 6 is a flowchart illustrating a data processing method performed by a data processing system according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. Like reference numerals denote like elements throughout the drawings.

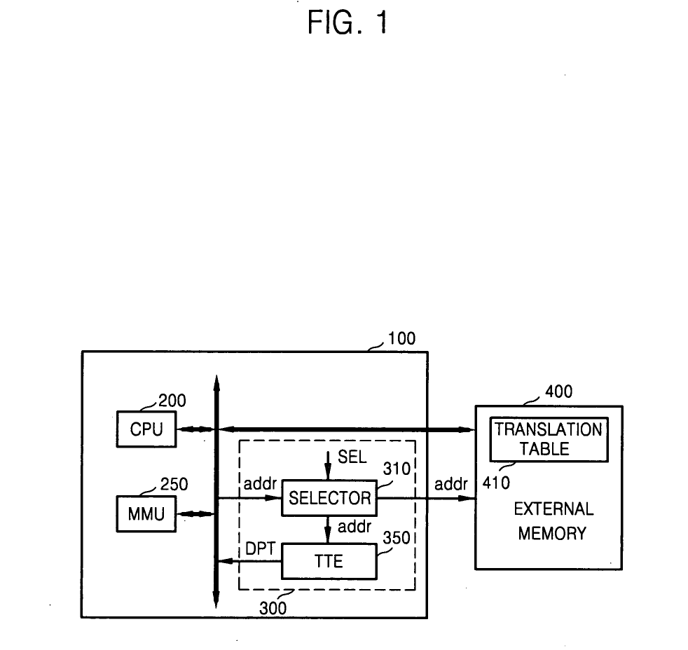

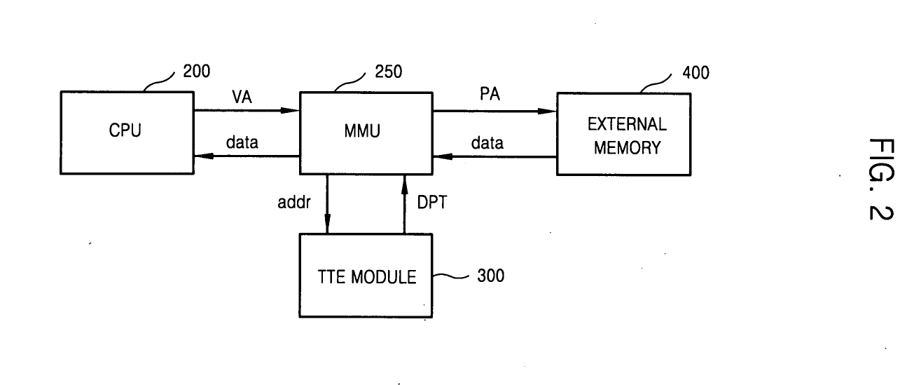

FIG. 1 is a schematic block diagram of a data processing system 100 according to an exemplary embodiment of the present invention. FIG. 2 is a block diagram illustrating the operation of the data processing system 100 of FIG. 1.

Referring to FIGS. 1 and 2, the data processing system 100 includes a central processing unit (CPU) 200, a memory management unit (MMU) 250, and a transition table emulation (TTE) module 300. The TTE module 300 includes a selector 310, and a TTE unit 350. An external memory 400 includes a translation table 410.

The data processing system 100 includes a bus acting as a common electrical path via which information is exchanged among the CPU 200, the MMU 250, the TTE module 300, and the external memory 400. To read data from or write data to the external memory 400, the CPU 200 uses a virtual address to designate the location of the data. However, for actual access to the external memory 400, the virtual address must be transformed into a physical address. The MMU 250 transforms the virtual address into the physical address. When the CPU 200 outputs a virtual address VA across the bus for access to the external memory 400, the MMU 250 receives the virtual address VA, generates a translation table address addr from the virtual address VA, and outputs the translation table address addr. The translation table address addr is a physical address used to access the translation table.

The selector 310 of the TTE module 300 receives the translation table address addr, and outputs it to the TTE unit 350 or the translation table 410 of the external memory 400 in response to a control signal SEL. For example, a value of the control signal SEL is set to a ‘1’ in a TTE mode or set to a ‘0’ in a mode in which the translation table 410 of the external memory 400 is accessed. The selector 310 selects the TTE unit 350 when the value of the control signal SEL is ‘1’ and accesses the translation table 410 of the external memory 400 when the value of the control signal SEL is ‘0’.

When the value of the control signal SEL is ‘1’, i.e., in the TTE mode, the TTE unit 350 receives the translation table address addr, generates a descriptor DPT, and outputs the descriptor DPT across the bus. The MMU 250 receives the descriptor DPT, maps the virtual address VA to a physical address PA by using the received descriptor DPT, accesses the external memory 400 by using the physical address PA, and records data to or reads data from a location corresponding to the physical address PA.

If the value of the control signal SEL is ‘0’, i.e., in the mode in which the translation table 410 of the external memory 400 is accessed, the MMU 250 receives a descriptor of the translation table 410, which corresponds to the translation table address addr, transforms the virtual address VA into a physical address PA by using the received descriptor, and accesses the external memory 400 to extract data from the external memory 400.

For direct access to the translation table 410 of the external memory 400, an initialization process must be performed to match all virtual addresses VA with physical addresses PA. Therefore, the selector 310 preferably selects the TTE module 300. When the TTE module 300 cannot generate a descriptor corresponding to the translation table address addr, the MMU 250 accesses the translation table 410 of the external memory 400.

In an exemplary embodiment of the present invention, the translation table 410 is included in the external memory 400 and the selector 310 is included in the TTE module 300. However, in exemplary embodiment of the present invention, only the TTE mode is used, and the translation table 410 and the selector 310 may be omitted.

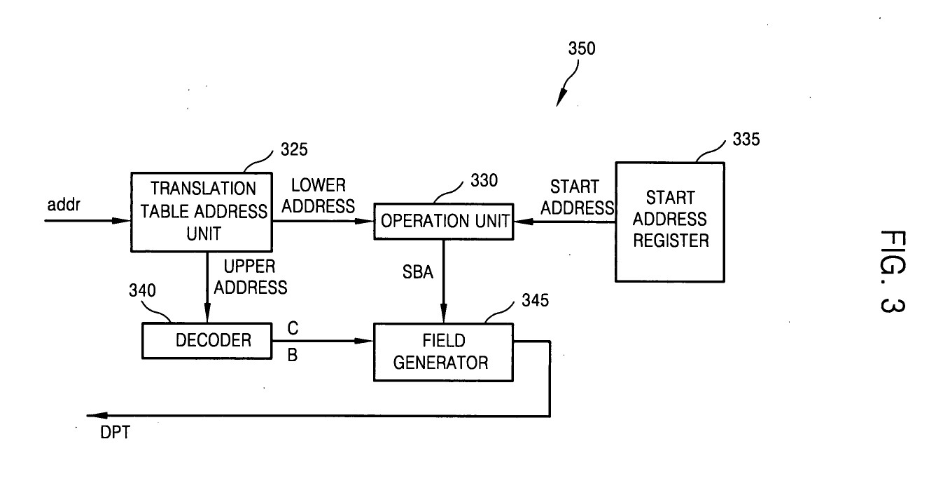

FIG. 3 is a block diagram of the TTE unit 350 according to an exemplary embodiment of the present invention. Referring to FIG. 3, the TTE unit 350 includes a translation table address unit 325, an operation unit 330, a start address register 335, a decoder 340, and a field generator 345.

The translation table address unit 325 receives a translation table address addr comprised of upper and lower addresses. The translation table address unit 325 outputs the upper address to the decoder 340 and the lower address to the operation unit 330.The decoder 340 receives the upper address, and outputs a cache value C and a buffer value B obtained by decoding the upper address. The start address register 335 outputs a start address of a translation table. The operation unit 330 receives the lower address and the start address, and subtracts the lower address from the start address to output a section-base address (SBA). For example, for access to the translation table address addr starting from an address 301100, the decoder 340 receives an upper address of 301 and the operation unit 330 receives a lower address of 100. A start address of 100 is output to the operation unit 330. Then, the operation unit 330 subtracts the lower address of 100 from the start address 100 and outputs an SBA corresponding to an address of 0.

The field generator 345 receives the cache value C and the buffer value B from the decoder 340, and the SBA from the operation unit 330. The field generator 345 determines an attribute of the SBA according to the cache value C and the buffer value B.

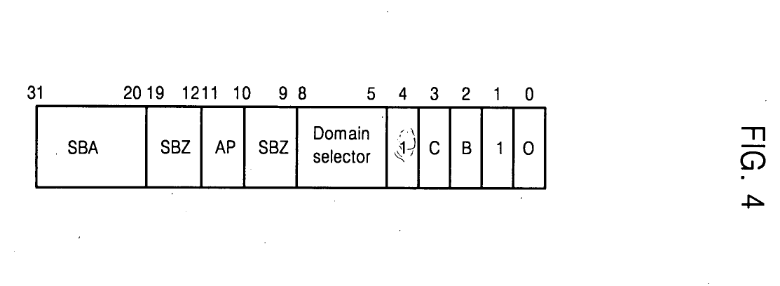

The field generator 345 determines the SBA based on the cache value C and the buffer value B, generates a descriptor DPT, such as that shown in FIG. 4, by using the cache value C, the buffer value B, and the SBA, and returns the descriptor DPT to the MMU 250. FIG. 4 is a detailed diagram illustrating the structure of a descriptor according to an exemplary embodiment of the present invention. Referring to FIG. 4, the values of fields SBZ, AP, and Domain selector may be predetermined. The descriptor illustrated in FIG. 4 is data generated by the TTE module 300 of FIG. 1 and is the same as the descriptor of the translation table 410 output to the external memory 400 of FIG. 1.

Referring to FIG. 4, the descriptor is comprised of 32-bit (0 to 31 bits) data. Specifically, the descriptor comprises an SBA field, “should-be-zero” (SBZ) fields, an access permission (AP) field, a dependent execution bit [4], and a domain selector field. Although the bit length of the descriptor is illustrated in FIG. 4 as 32 bits, this is merely an exemplary embodiment. The descriptor may be any number of bits and is not limited to a bit length of 32 bits.

Bits [1:0] represent the type of the descriptor. Bits [3:2] represent a cache value C and a buffer value B, respectively. The cache value C indicates whether data can be cached in each descriptor. When data can be cached, a subsequent operation can be performed without reading data from a main memory. The cache value C may indicate that a command can be read before completing a current operation. The cache value C may be individually set for each descriptor. The buffer value B indicates that data in each descriptor may be stored in a write buffer.

Bit [4] is a dependent execution bit. Bits [8:5] are domain selector bits and represent a maximum of 16 domains designated for all sections controlled by the descriptor. Bit [9] is an “SBZ” bit that is not currently used.

Bits [11:10] are AP bits that represent whether access to a section descriptor is allowed and is used to control a corresponding section. Bits [19:12] are SBZ bits that are not currently used. Bits [31:20] are SBA bits that constitute upper-rank 12 bits of a physical address. In an exemplary embodiment of the present invention, if an SBA value, a cache value C, and a buffer value B are determined, a descriptor can be generated.

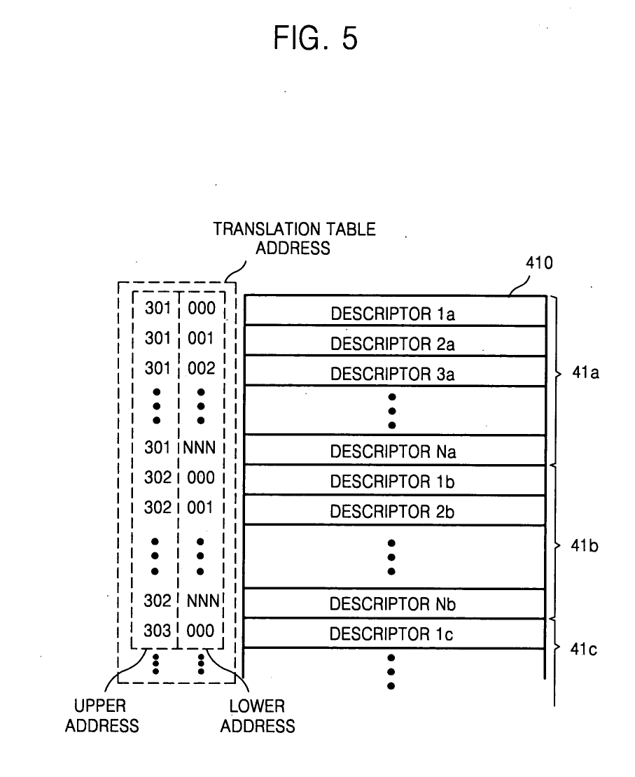

FIG. 5 is a block diagram of a translation table 410 according to an exemplary embodiment of the present invention. The translation table 410 illustrated in FIG. 5 may be loaded as an external translation table into an external memory but may be generated by the TTE module 300 of FIG. 1.

Referring to FIG. 5, the translation table 410 consists of descriptors and translation table addresses addr. Each of the translation table addresses addr is categorized into an upper address and a lower address. Although the length of the translation table addresses in FIG. 5 is illustrated as 6 bits, this is merely an exemplary embodiment. The length of each translation table address addr may be any number of bits and is not limited to 6 bits. Although the length of the upper and lower addresses in FIG.5 are illustrated as 3 bits, this is merely an exemplary embodiment. The lengths of the upper and lower addresses may be any number of bit and are not limited to 3 bits.

The translation table 410 is divided into a first section 41a, a second section 41b, and a third section 41c according to upper addresses. The descriptors of each of the first section 41a, the second section 41b, and the third section 41c have the same cache value C and the same buffer value B. Attributes of the cache value C and the buffer value B are predetermined according to an upper address, and then, fields of a descriptor are generated based on the predetermined attributes.

For example, the cache values C and the buffer values B of descriptors of a section (the first section 41a) of the translation table 401 having an upper address 301, i.e., descriptors having addresses from ‘301000’ to ‘301NNN’, may be set to 0. It is possible to control a write/read operation by adjusting the cache value C and the buffer value B.

As described above, since a cache value and a buffer value are predetermined according to an upper address, the TTE unit 350 is capable of generating a cache value C and a buffer value B corresponding to an upper address. The SBA may be computed by using a start address and a lower address as described above. In an exemplary embodiment of the present invention, a cache value C and a buffer value B are predetermined according to an upper address of a translation table address addr, and translation table data (descriptor). The cache value C and the buffer value B are not predetermined according to an actual translation table (a translation table loaded into an external memory), but are generated through internal translation table emulation. Thus, a translation table need not be loaded into an external memory, nor be initialized. A program that requires the TTE module 300 of FIG. 1 can be loaded even with a small capacity of a memory.

According to an exemplary embodiment of the present invention, the TTE module 300 is formed together with the CPU 200 and the MMU 250 on the same chip. The TTE module 300 may also be implemented as a separate hardware chip.

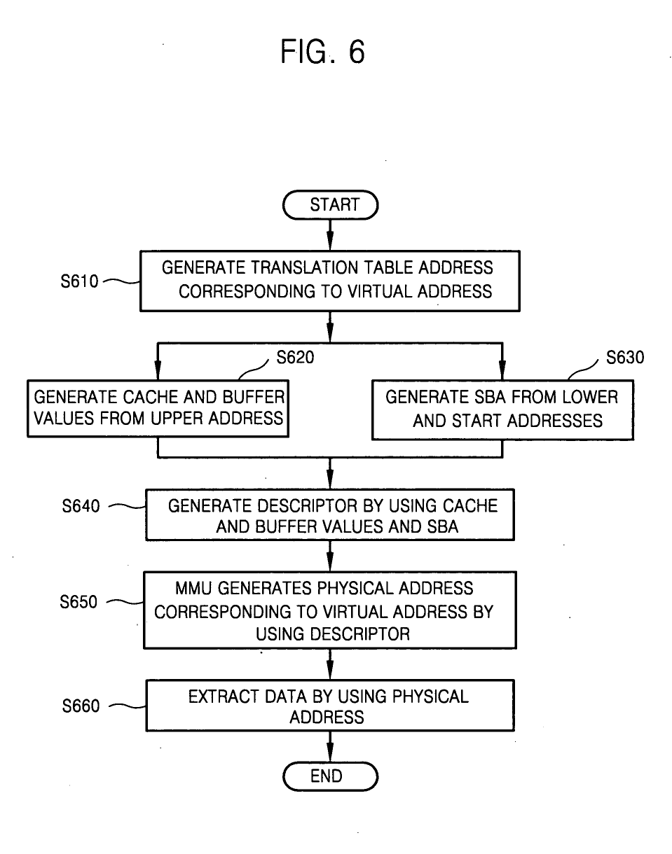

FIG. 6 is a flowchart illustrating a method of processing data by using the TTE unit 350 of FIG. 3 according to an exemplary embodiment of the present invention. Referring to FIGS. 3 and 6, the MMU 250 generates a translation table address addr corresponding to a virtual address (S610). Next, the decoder 340 generates a cache value C and a buffer value B from an upper address of the translation table address addr (S620), and the operation unit 330 generates an SBA by using the upper address and a lower address of the translation table address addr (S630). Next, the field generator 345 generates a descriptor by using the cache value C, the buffer value B, and the SBA (S640). Next, the MMU 250 generates a physical address corresponding to the virtual address by using the descriptor (S650). Next, the MMU 250 extracts data by using the physical address (S660).

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A data processing system comprising:
a central processing unit outputting a virtual address;
a memory management unit generating a translation table address corresponding to the virtual address and transforming the virtual address into a physical address by using a descriptor; and
a translation table emulation module receiving the translation table address and generating the descriptor needed to map the virtual address to the physical address.

2. The data processing system of claim 1, wherein the translation table emulation module comprises:
a translation table emulation unit generating the descriptor; and
a selector selecting one of an external memory into which an external translation table is loaded, and the translation table emulation unit.

3. The data processing system of claim 2, wherein the translation table emulation unit comprises:
a start address register outputting a predetermined start address;
an operation unit generating a section base address from the start address and a lower address of the translation table address;
a decoder outputting a cache value and a buffer value corresponding to an upper address of the translation table address; and
a field generator generating the descriptor based on the cache value, the buffer value, and the section base address.

4. The data processing system of claim 3, wherein, when upper addresses of the translation table address are the same, the decoder sets cache values of descriptors having the same upper addresses to a first value, and buffer values of the descriptors to a second value.

5. The data processing system of claim 3, wherein the field generator further uses a predetermined field value to generate the descriptor.

6. The data processing system of claim 2, wherein the descriptor is the same as a descriptor of the external translation table.

7. A data processing system comprising:
a memory management unit transforming a virtual address into a physical address by using a descriptor having a plurality of attribute values; and
a translation table emulation module receiving a translation table address which is based on the virtual address, and generating the descriptor by setting the attribute values based on the translation table address.

8. The data processing system of claim 7, wherein the translation table emulation module comprises:
a start address register outputting a predetermined start address;
an operation unit computing a section base address from the start address and a lower address of the translation table address;
a decoder outputting a cache value and a buffer value corresponding to an upper address of the translation table address; and
a field generator generating the descriptor based on the cache value, the buffer value, and the section base address.

9. The data processing system of claim 8, wherein, when upper addresses of the translation table address are the same, the decoder sets cache values of descriptors having the same upper addresses to a first value, and buffer values of the descriptors to a second value.

10. The data processing system of claim 7, wherein the translation table emulation module is implemented in hardware.

11. A method of processing data which is performed by a data processing system, comprising:
generating a translation table address corresponding to a virtual address;
setting a plurality of attribute values based on the translation table address, and generating a descriptor including the attribute values;
transforming the virtual address into a physical address by using the descriptor; and
accessing the data by using the physical address.

12. The method of claim 11, wherein setting the plurality of attribute values based on the translation table, and generating the descriptor including the attribute values comprises:
generating a cache value and a buffer value from an upper address of the translation table address;
generating a section base address by using a lower address of the translation table address and a predetermined start address; and
generating the descriptor based on the cache value, the buffer value, and the section base address.

13. The method of claim 12, wherein when upper addresses of the translation table address are the same, cache values of descriptors having the same upper addresses are set to a first value, and buffer values of the descriptors are set to a second value.

14. The method of claim 12, wherein the descriptor is further generated from a predetermined field.
